(19) United States
(12) Patent Application Publication
(10) Pub. No.: US 2022/0220241 A1
(43) Pub. Date: Jul. 14, 2022

(54) ZWITTERIONIC CHARGED COPOLYMER MEMBRANES

(71) Applicant: Trustees of Tufts College, Medford, MA (US)

(72) Inventors: Ayse Asatekin Alexiou, Arlington, MA (US); Samuel John Lounder, Medford, MA (US)

(21) Appl. No.: 17/610,230

(22) PCT Filed: May 8, 2020
(86) PCT No.: PCT/US20/32068

§ 371 Date: Nov. 10, 2021

Related U.S. Application Data
(60) Provisional application No. 62/846,014, filed on May 10, 2019.

(51) Int. Cl. C08F 220/24; B01D 71/40; B01D 71/32; B01D 69/02; C08J 5/18

(52) U.S. Cl. CPC C08F 220/24; B01D 71/40; B01D 71/32; B01D 69/02; C08J 2333/10; B01D 2325/30; B01D 2325/18; B01D 2325/02; C08J 2333/02; C08J 5/18

(57) ABSTRACT

Disclosed are linear/random/statistical copolymers comprising three types of monomeric units: hydrophobic monomeric units, zwitterionic monomeric units, and charged or ionizable monomeric units. Also provided are thin film composite membranes whose selective layer is comprised of the copolymers disclosed herein, and the methods of use thereof.

### RELATED APPLICATIONS

This application claims the benefit of U.S. Provisional Application No. 62/846,014, filed May 10, 2019, the contents of which are incorporated herein by reference in their entirety.

### GOVERNMENT SUPPORT

This invention was made with government support under grants 1508049 and 1553661 awarded by the National Science Foundation. The government has certain rights in the invention.

### BACKGROUND

Nanofiltration (NF) membranes are defined by effective pore sizes ˜1 nm. They are typically used for removing divalent salts from water and wastewater streams in applications such as water softening. Almost all commercial NF membranes on the market today feature cross-linked polyamide selective layers, prepared by interfacial polymerization. This selective layer chemistry has been used for decades, and as a result, these commercial membranes are very well-optimized and offer reasonably high water permeability along with the desired divalent salt rejection.

However, polyamide selective layers also come with significant limitations inherent to their chemical structure, such as lack of fouling and chlorine resistance. Recently, zwitterions have attracted extensive research in the membrane field due to their hydrophilicity and fouling resistance. Zwitterionic amphiphilic copolymers (ZACs) are documented to self-assemble to create microstructures. And that when ZACs are used as membrane selective layers, fouling resistant membranes with ˜1-2 nm effective pore size etc can be achieved. These membranes were also shown to be highly chlorine resistant.

However, an important feature of these membranes was that they exhibited relatively low salt rejection due to the overall neutral chemistry of the membrane selective layer. Therefore, while ZACs offer promising fouling and chlorine resistance as well as effective pore sizes close to that of NF membranes, their rejection profiles are not sufficient for replacing commercial NF membranes in most applications. Therefore, there is a need to develop high performance membranes that do not have the aforementioned drawbacks.

### SUMMARY

Provided herein are copolymers comprising pluralities of each of three types of monomeric units: hydrophobic monomeric units, zwitterionic monomeric units, and charged or ionizable monomeric units. Preferably the copolymers are linear, statistical, or random, or all of them. Also provided are thin film composite membranes whose selective layer is comprised of these copolymers. These membranes can be used for several aqueous separations, including but not limited to water treatment, water softening, wastewater treatment, and separation and purification of organic molecules in aqueous solutions. Due to the chemical nature of these copolymers, the membranes exhibit improved resistance to chemical degradation by chlorine and strong resistance to fouling.

In one aspect, provided herein are copolymers, comprising a plurality of zwitterionic monomeric units, a plurality of charged/ionizable monomeric units, and a plurality of hydrophobic monomeric units.

In yet another aspect, provided herein are thin film composite membranes, comprising a porous support, and a thin film of the polymeric material, wherein the pore size of the porous support is larger than the effective pore size of the thin film of the polymer material.

In another aspect, provided herein are methods of size-based selection or exclusion, comprising contacting a solution comprising a plurality of uncharged organic molecules of different sizes with a thin film composite membrane disclosed herein.

In further another aspect, provided herein are methods of charge-based selection or exclusion, comprising contacting a solution comprising a plurality of salts with a thin film composite membrane disclosed herein.

### BRIEF DESCRIPTION OF THE DRAWINGS

FIG. 1 is a scheme that depicts polymer architecture/chemistry of a Charged

Zwitterionic Amphiphilic Copolymer (CZAC), P(TFEMA-r-SBMA-r-MAA), and schematic description of its self-assembly when coated onto a support to form a membrane selective layer, featuring ˜1-2 nm hydrophilic domains that act as a network of effective nanochannels lined with carboxylate groups.

FIG. 2 depicts the ¹H NMR spectrum of PTFEMA-SBMA-MAA-B1, indicating copolymerization.

FIG. 3 depicts the ¹H NMR spectrum of PTFEMA-SBMA-MAA-B2, indicating copolymerization.

FIG. 4A depicts an SEM image of an uncoated Trisep UE50 support membrane.

FIG. 4B depicts an SEM image of a PTFEMA-SBMA-MAA-B1 TFC membrane.

FIG. 4C depicts an SEM image of a PTFEMA-SBMA-MAA-B2 TFC membrane.

FIG. 5A is a bar graph depicts the rejection of neutral (Rib, RH, and VB12) and anionic (Na2SO4, MO, AB45) solutes by PTFEMA-SBMA membrane, PTFEMA-SBMA-MAA-B1 membrane, and PTFEMA-SBMA-MAA-B2 membrane.

FIG. 5B is a graph that depicts the rejection of sugars and dyes by membranes prepared as described in Example 2B.

FIG. 6A is a bar graph that depicts the rejection of various salts at concentrations of 1 mM and 5 mM by PTFEMA-SBMA membrane, PTFEMA-SBMA-MAA-B1 membrane, and PTFEMA-SBMA-MAA-B2 membrane.

FIG. 6B is a graph that depicts the rejection of Na₂SO₄ (C_{Feed}=5 mM) at varying pH by PTFEMA-SBMA-MAA-B1.

FIG. 6C is a bar graph that depicts PTFEMA-SBMA-MAA-B2 rejection of various salts at concentrations of 1 mM and 5 mM. The rejections are fitted to the DSPM (For C_{Feed}=1 mM: Dₚₒᵣₑ=1.95 nm, δ_{effective}=20 μm, and X=21.4 mM. For C_{feed}=5 mM: Dₚₒᵣₑ=1.95 nm, δ_{effective}=20 μm, and X=60.4 mM).

FIG. 7A is a bar graph that depicts the rejection of various neutral dyes.

FIG. 7B is a bar graph that depicts the rejection of various anionic dyes and Na₂SO₄

FIG. 8A is a graph that depicts oil emulsion fouling resistance for PTFEMA-SBMA-MAA-B2 membrane (stabilized by Span80 neutral surfactant);

FIG. 8B is a graph that depicts oil emulsion fouling resistance for PTFEMA-SBMAMAA-B2 membrane (stabilized by DC 193 neutral surfactant).

FIG. 8C is a graph that depicts the fouling resistance of CZAC membranes against BSA and CaCl₂ mixture (1.0 g/L BSA, 10 mM CaCl2, pH=6.3, and J₀ 5.4 LMH). Commercial NF membranes were used as benchmarks.

FIG. 8D is a graph that depicts the fouling resistance of CZAC membranes against Humic acid and aliginate mixture (1 g/L for each, pH 4.5, J₀=7.0 LMH). Commercial NF membranes were used as benchmarks.

FIG. 9 is a graph that depicts the permeance of PTSBMA-SBMA-MAA before and after Clorox treatment.

FIG. 10 is an IR spectrum that depicts the effect of chlorine treatment on PTFEMASBMA-MAA-B2 bond chemistry. FTIR spectra taken before and after 16 hours of immersion in 2,000 ppm sodium hypochlorite solution at pH 4.5.

FIG. 11 is a graph that depicts the rearrangement of PTFEMA-SBMA-MAA-B1 upon exposure to a PBS solution, followed by the switchable flux behavior that was observed afterwards.

FIG. 12A is a bar graph that depicts the rearrangement of PTFEMA-SBMA-MAA-B1 membranes by NaOH_{(aq)} (pH=11).

FIG. 12B is a bar graph that depicts the permeance of PTFEMA-SBMA membranes during filtration of NaOH_{(aq)} (pH=11).

FIG. 13 is a bar graph that depicts the rejections of Vitamin B12 and Na₂SO₄ before and after rearrangement via NaOH_{(aq)} treatment.

FIG. 14 is a bar graph that depicts the membrane permeance versus Filtration ID (in Table 5).

FIG. 15 is a bar graph that depicts the permeance of rearranged PTFEMA-SBMA-MAA membranes in response to a basic solution containing calcium.

FIG. 16 is graph that depicts the correlation between reaction mixture composition and the composition of the resultant terpolymer, indicating close to random monomer sequence.

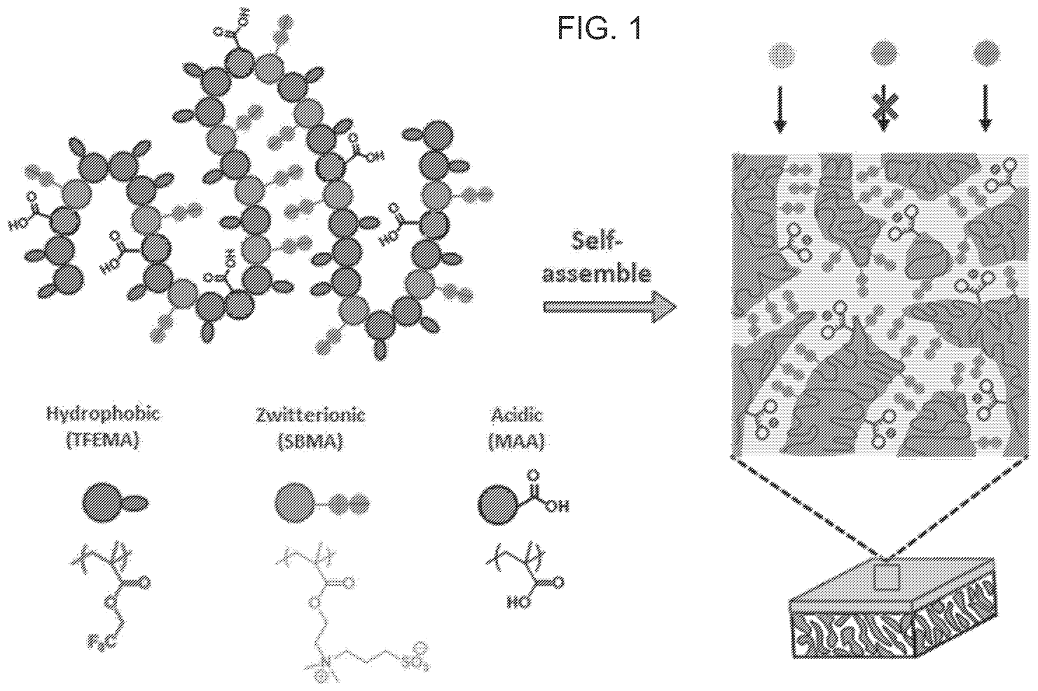

### DETAILED DESCRIPTION

Disclosed are membranes that combine NF-type selectivity with fouling- and chlorine-resistance by leveraging the self-assembling properties of ZACs and modifying this polymer family to improve salt rejection. Specifically, disclosed are charged zwitterionic amphiphilic copolymers (CZACs) and membranes prepared with CZAC selective layers through scalable manufacturing techniques. The CZACs are random or statistical terpolymers of three types of monomers: hydrophobic monomer, zwitterionic monomer, and acidic/ionizable monomer. Preferably, the copolymers are linear, random, and statistical. The random/statistical architecture of the copolymers and zwitterion-zwitterion attractive forces grant this terpolymer the ability to self-assemble into a bicontinuous network comprised of 1-2 nm hydrophilic (zwitterionic/charged) and hydrophobic nanodomains. Water and other solutes pass through the hydrophilic domains, which act as an effective network of nanochannels with charged walls. This allows the terpolymer to serve as a membrane selective layer. The hydrophilic nanochannel is net charged due to the ionization of the incorporated functional groups (e.g. deprotonation of an acidic repeat unit, protonation of an amine group, dissociation of a sulfonate group), which enhances the rejection of charged solutes and salt ions. Due to the presence of zwitterionic groups, these membranes are highly fouling resistant. The use of a novel polymer chemistry enables high chlorine resistance, with no changes in performance upon exposure to 32,000 ppm.hours of chlorine.

Disclosed is a family of polymeric materials that comprise pluralities of at least three types of repeat units:
1. A zwitterionic repeat unit, which leads to the formation of a bicontinuous network of hydrophilic/water permeable nano-domains that act as permeation pathways for water and aqueous solutions that contain solutes smaller than domain size, preferably typically <5 nm, and preferably 0.6-3 nm, and more preferably 0.6-2 nm.
2. A charged or ionizable repeat unit, which imparts charge-based selectivity and ion retention properties through Donnan exclusion mechanisms.
3. A relatively hydrophobic repeat unit, which limits the swelling of the polymer in water and imparts the polymer stability in aqueous environments. This hydrophobic repeat unit is preferably derived from a monomer whose homopolymer is not soluble in water, and has a glass transition temperature above use temperature (e.g., above room temperature).

The polymers, which are termed “Charged Zwitterionic Amphiphilic Copolymers” (CZACs), may be synthesized from vinyl monomers (e.g., acrylates, methacrylates, acrylamides, styrene derivatives, acrylonitrile) using well-known polymerization methods (e.g., free radical polymerization). The polymers incorporate the three types of repeat units in roughly random/statistical order (as opposed to in large blocks of individual monomers), and have a molecular weight from 20,000 g/mol to 1,000,000 g/mol (preferably from 40,000 g/mol, or 100,000 g/mol to 1,000,000 g/mol). Preferably, the copolymers are linear.

In certain compositions suitable for the application/embodiment described below for membrane selective layers, the CZACs comprise ˜30-80 wt % of the hydrophobic monomer, 1-40 wt % of the charged monomer, and 1-40 wt % of the zwitterionic monomer. Broader ranges of compositions may be of use in other applications.

Exemplary monomers for formation of each type of repeat unit are listed below.

Zwitterionic: Sulfobetaine methacrylate (SBMA)*; methacryloxy phosphoryl choline (MPC); carboxybetaine methacrylate (CBMA); sulfobetaine-2-vinylpyridine; sulfobetaine-4-vinylpyridine; sulfobetaine-vinyl imidazole; and several others comprising sulfobetaine, carboxybetaine, or phosphorylcholine moieties.

Charged/ionizable: Methacrylic acid (MAA)*; acrylic acid; styrene sulfonate; methacrylate, acrylate, acrylamide or styrene derivatives containing carboxylic acid, sulfonate, amine, phosphate, or other ionizable/charged groups

Relatively hydrophobic: 2,2-trifluoroethyl methacrylate (TFEMA)*; other fluorinated acrylates, methacrylates, and acrylamides (e.g., pentafluoropropyl methacrylate, heptafluorobutyl methacrylate, pentafluorophenyl methacrylate); styrene; methyl methacrylate; acrylonitrile; other monomers that fit the above criteria.

Utilities of the polymeric materials are discussed below, particularly in the context of their use as membrane selective layers. However, they can potentially be useful for other applications (e.g., as additives in membrane manufacture, compatibilizers).

The CZACs may be coated onto porous supports by methods understood in the membrane industry (e.g., blade coating, non-solvent induced phase separation (NIPS), spray coating). This results in a thin film composite (TFC) membrane, comprising at least two layers: A porous support with large pores, providing mechanical integrity; and a thin layer (thickness preferably <10 μm, more preferably <3 μm or <1 μm) of the CZAC, serving as the “selective layer” of the membrane. In this embodiment, the CZAC layer typically contains a continuous dense layer of CZAC (i.e., not regular “through-pores” providing pathways for water permeation, with the exception of occasional defects that may appear in processing even if they are not desired); in other words, water should permeate through the CZAC, as the main transport mechanism, rather than through pores/holes in it.

The resultant membranes exhibit size-based separation of neutral organic molecules, but also higher rejection of charged solutes than neutral solutes. This quality is useful for several applications where size-based separation is not sufficient. For example, if full or partial removal of contaminants is desired, the combination of size-based and charge-based rejection offered by these membranes can lead to better effluent quality. Alternatively, these membranes can separate two organic solutes (e.g., amino acids, drug compounds) from each other that differ by the presence of a charged group.

The current membranes can be modified and tuned to increase salt rejection to address reverse osmosis (RO)/desalination processes and engineered osmosis (EO), or to access slightly larger pore sizes to have charge-selective tight ultrafiltration (UF) membranes.

Commercial NF and RO/EO membranes almost universally have cross-linked polyamide selective layers. Such membranes suffer from two major problems: First, they are prone to fouling, requiring several pretreatment steps that impact the cost and energy efficiency of the overall process for desalination. Second, the membranes are highly sensitive to chlorine, which reacts with the selective layer. Chlorination is typically used to kill microorganisms in the incoming water to desalination facilities to prevent biofouling. Due to the chlorine sensitivity of commercial NF and RO membranes, the water is dechlorinated before being fed to the NF or RO units, then chlorinated again before being sent to customers.

The current membranes circumvent both of these issues: Zwitterionic groups are known and demonstrated to be highly resistant to fouling. The membranes are shown to be exceptionally resistant to fouling by an organic stream. Furthermore, the constituent polymers are not inherently prone to attack by chlorine. The membranes are shown to be stable to commercial chlorine bleach.

The membranes may undergo a pore rearrangement when subjected to high-pH buffers. When exposed to a high-pH buffer solution, membranes with some CZAC selective layers exhibit a one-time, irreversible and stable increase in permeability, along with a slight increase in pore size.
CZACs from the hydrophobic monomer TFEMA, zwitterionic monomer SBMA, and ionizable monomer MAA can be synthesized by free radical polymerization at multiple monomer ratios.
This copolymer self-assembles to create a network of hydrophilic nanodomains that act as water permeation pathways.
The membranes can be coated onto commercial, large pore membranes as porous supports to create thin film composite (TFC) membranes.
The membranes exhibit permeances (defined as flux/applied pressure difference) comparable to commercial RO and NF membranes. This can be further improved by decreasing coating thickness, and by changing polymer formulation.
The membranes exhibit size-based selectivity between uncharged organic molecules, including Vitamin B12 and β-cyclodextrin, with rejections around 92%. Models of rejection lead to an estimated effective pore size around 2 nm. This pore size can be tuned through polymer chemistry and other methods to lower and higher values (1-5 nm appears to be an accessible range).
The membranes exhibit significantly higher rejection of charged solutes than uncharged solutes of similar size.
The membranes exhibit significant salt rejection, including NaSO4 rejections around 95%, comparable with some NF membranes.
The polymer is stable upon exposure to chlorine bleach (e.g., at pH 4).
The membranes are highly resistant to fouling by an oil emulsion.
Upon exposure to buffers with relatively high pH, the membranes exhibit a one-time increase in flux, accompanied with a slight decline in rejection. The new flux and pore size is stable; the change is not reversible. Additionally, the membranes attain switchable flux in different ionic solutions, which may be controlled by the cation present in the solution.

In one aspect, provided herein are copolymers, comprising a plurality of zwitterionic monomeric units, a plurality of charged/ionizable monomeric units, and a plurality of hydrophobic monomeric units.

In some embodiments, the molecular weight of the copolymer is 20,000 g/mol to 1,000,000 g/mol. In some embodiments, the molecular weight of the copolymer is 40,000 g/mol to 1,000,000 g/mol. In some embodiments, the molecular weight of the copolymer is 100,000 g/mol to 1,000,000 g/mol.

In some embodiments, the zwitterionic monomeric units constitute 1-40 wt % of the copolymer. In some embodiments, the charged/ionizable monomeric units constitute 1-40 wt % of the copolymer. In some embodiments, the hydrophobic monomeric units constitute 30-80 wt % of the copolymer.

In some embodiments, each of the zwitterionic monomeric units is formed from a monomer comprising sulfobetaine, carboxybetaine, or phosphorylcholine moieties. In some embodiments, each of the zwitterionic monomeric units is formed from a monomer selected from the group consisting of sulfobetaine methacrylate (SBMA), methacryloxy phosphoryl choline (MPC), carboxybetaine methacrylate (CBMA), sulfobetaine-2-vinylpyridine, sulfobetaine-4-vinylpyridine, and sulfobetaine-vinyl imidazole. In some embodiments, each of the zwitterionic monomeric units is formed from sulfobetaine methacrylate (SBMA).

In some embodiments, each of the charged/ionizable monomeric units is formed from a monomer selected from the group consisting of a methacrylate, an acrylate, an acrylamide or a styrene derivative comprising carboxylic acid, sulfonate, phosphate, or amine moieties. In some embodiments, each of the charged/ionizable monomeric units is formed from a monomer selected from the group consisting of methacrylic acid (MAA), acrylic acid, 2-carboxyethyl acrylate, 2-carboxyethyl methacrylate, styrene sulfonate, 3-sulfopropyl acrylate, 3-sulfopropyl methacrylate, 2-acrylamido-2-methyl-1-propanesulfonic acid, 2-(dimethylamino)ethyl methacrylate, 2-(diethylamino)ethyl methacrylate, 2-aminoethyl methacrylate, [2-(methacryloyloxy)ethyl]trimethylammonium chloride, [2-(acryloyloxy)ethyl]trimethylammonium chloride, 2-(diethylamino)ethyl acrylate, 2-(dimethylamino)ethyl acrylate, 3-(dimethylamino)propyl acrylate, N-acryloyl-L-valine, (3-acrylamidopropyl)trimethylammonium chloride, N[3-dimethylamino)propyl]methacrylamide, (2-isopropenylaniline, 4-[N-(methylaminoethyl)aminomethyl]styrene, and (vinylbenzyl)trimethylammonium chloride. In some embodiments, each of the charged/ionizable monomeric units is formed from methacrylic acid (MAA).

In some embodiments, each of the hydrophobic monomeric units is formed from a monomer selected from the group consisting of styrene, methyl methacrylate, acrylonitrile, a fluoroalkyl acrylate, a fluoroaryl acrylate, a fluoroalkyl methacrylate, a fluoroaryl methacrylate, a fluoroalkyl acrylamide, and a fluoroaryl acrylamide. In some embodiments, each of the hydrophobic monomeric units is formed from a monomer selected from the group consisting of a fluoroalkyl acrylate, a fluoroaryl acrylate, a fluoroalkyl methacrylate, a fluoroaryl methacrylate, a fluoroalkyl acrylamide, and a fluoroaryl acrylamide. In some embodiments, each of the hydrophobic monomeric units is formed from a monomer selected from the group consisting of 2,2-trifluoroethyl methacrylate (TFEMA), pentafluoropropyl methacrylate, heptafluorobutyl methacrylate, and pentafluorophenyl methacrylate. In some embodiments, each of the hydrophobic monomeric units is formed from 2,2-trifluoroethyl methacrylate (TFEMA).

In some embodiments, hydrophobic monomeric units are characterized in that a homopolymer formed thereof has a glass transition temperature above room temperature.

In some embodiments, the copolymer is a random copolymer.

In some embodiments, the copolymer is a statistical copolymer.

In some embodiments, the copolymer is a linear copolymer.

In some embodiments, the copolymer is poly((sulfobetaine methacrylate)-random-(methacrylic acid)-random-(2,2-trifluoroethyl methacrylate)).

In another aspect, provide herein are polymeric materials comprising a plurality of the copolymers. In some embodiments, the polymeric material is in the form of a thin film.

In yet another aspect, provided herein are thin film composite membranes, comprising a porous support, and a thin film of the polymeric material, wherein the pore size of the porous support is larger than the pore size of the thin film of the polymer material.

In some embodiments, the thin film of the polymeric material has a thickness of 1 nm to 10 μm. In some embodiments, the thin film of the polymeric material has a thickness of 1 nm to 3 μm. In some embodiments, the thin film of the polymeric material has a thickness of 1 nm to 1 μm.

In some embodiments, the thin film of the polymeric material has an effective pore size of 0.1-5 nm. In some embodiments, the thin film of the polymeric material has an effective pore size of 0.6-3 nm. In some embodiments, the thin film of the polymeric material has an effective pore size of 0.6-2 nm.

In some embodiments, the thin film composite membrane exhibits resistance to fouling by an oil emulsion.

In some embodiments, the thin film composite membrane is stable upon exposure to chlorine bleach (e.g., at pH 4).

In some embodiments, the thin film composite membrane undergoes a one-time, irreversible change in pore size upon exposure to buffers with high pH.

In some embodiments, the thin film composite membrane exhibits size-based selectivity between uncharged organic molecules.

In some embodiments, the thin film composite membrane rejects charged solutes and salts.

In another aspect, provided herein are methods of size-based selection or exclusion, comprising contacting a solution comprising a plurality of uncharged organic molecules of different sizes with a thin film composite membrane disclosed herein.

In further another aspect, provided herein are methods of charge-based selection or exclusion, comprising contacting a solution comprising a plurality of salts with a thin film composite membrane disclosed herein.

### EXAMPLES

In order that the invention described herein may be more fully understood, the following examples are set forth. The examples described in this application are offered to illustrate the compounds, compositions, materials, device, and methods provided herein and are not to be construed in any way as limiting their scope.

### Example 1. Synthesis of Poly(trifluoroethylmethacrylate)-random-poly(sulfobetaine methacrylate)-random-poly (methacrylic acid) (PTFEMA-SBMA-MAA)

### Example 1A: Synthesis of PTFEMA-SBMA-MAA-B1

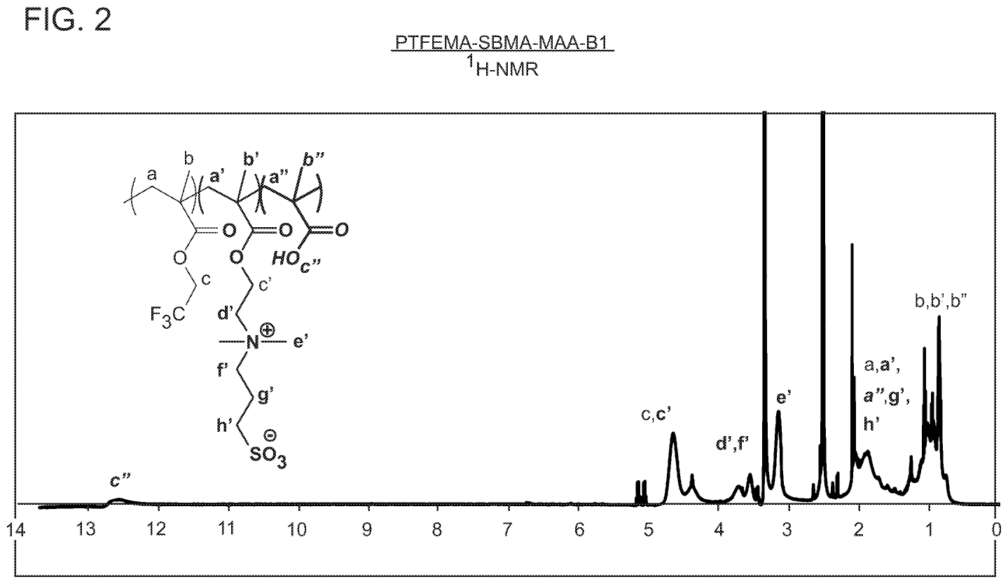

In this example, a random/statistical terpolymer of the monomers trifluoroethylmethacrylate (TFEMA), sulfobetaine methacrylate (SBMA), and methacrylic acid (MAA) (a terpolymer comprised of these three components will be generically termed PTFEMA-SBMA-MAA) was synthesized as follows. First, TFEMA and MAA were purified using basic alumina columns. Then DMSO (80 mL), purified TFEMA (5.49 g), SBMA (2.61 g), purified MAA (1.11 g), LiCl (0.090 g), and AIBN (11 mg) were added to a 250 mL flat bottom reaction flask, which was then sealed with a rubber septum. The mixture was then allowed to stir at room temperature for two days to dissolve the zwitterionic monomer. Afterwards, the flask was sealed with a rubber septum, purged with N₂ for 40 minutes, and then plunged into a 70° C. oil bath with stirring. After 20 hours, the reaction was terminated by exposure to air and the addition of MEHQ (0.5 g). For precipitation, the viscous polymer solution was then poured into an 800 mL mixture of ethanol and hexane (1:1 volume ratio.) The polymer was then cut into small pieces, and washed via stirring in an 800 mL mixture of ethanol and hexane (1:1 volume ratio) for over 12 hrs. This wash cycle was repeated 2 times. Afterwards, the polymer was left to dry under the hood for around 1 week, and finally dried in a 50° C. vacuum oven for over 24 hours. Yield was calculated as 38%, as determined by the by the weight of the dried polymer. This polymer will be termed PTFEMA-SBMA-MAA-B 1. The composition of the purified polymer was calculated from the ¹H-NMR spectrum (FIG. 2), through integration of the following three sets of peaks: (1) c″, (2) e′, (3) c, c′. The composition was calculated as 61.9 wt % TFEMA, 31.7 wt % SBMA, and 6.4 wt % MAA.

### Example 1B: Synthesis of PTFEMA-SBMA-MAA-B2

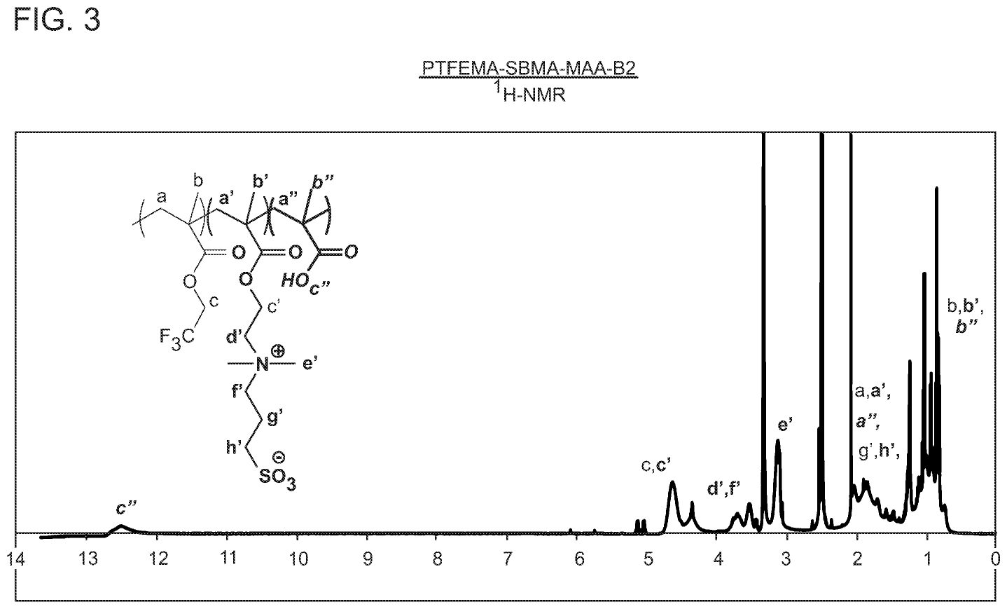

In this example, a random/statistical terpolymer of TFEMA, SBMA, and MAA was synthesized as follows. First, SBMA (2.80 g) and DMSO (87 mL) were added to a 250 mL flat bottom reaction flask. Temperature was raised to 70° C. to dissolve the zwitterionic monomer, and then returned to room temperature. During this the cool-down period, both TFEMA and MAA were purified using basic alumina columns (VWR). Following this, purified TFEMA (4.49 mL), purified MAA (1.86 mL), LiCl (0.10 g), and AIBN (9.8 mg) were added to the reaction flask. Afterwards, the flask was sealed with a rubber septum, purged with N₂ for 30 minutes, and then plunged into a 70° C. oil bath with stirring. After 20 hours, the reaction was terminated by exposure to air and the addition of MEHQ (0.7 g) dissolved in approximately 5 mL of DMSO. For precipitation, the viscous polymer solution was then poured into a 900 mL mixture of ethanol and hexane (1:1 volume ratio). The polymer was then cut into small pieces, and washed via stirring in a 900 mL mixture of ethanol and hexane (1:1 volume ratio) for 12 hrs. This wash cycle was repeated 3 times. Afterwards, the polymer was left to dry under the hood for around 1 week, and finally dried in a 50° C. vacuum oven for 4 days. Yield was calculated as 60%, as determined by the by the weight of the dried polymer. This polymer will be termed PTFEMA-SBMA-MAA-B2. The composition of the purified polymer was calculated from the ¹H-NMR spectrum (FIG. 3), through integration of the following three sets of peaks: (1) c″, (2) e′, (3) c, c′. The composition was calculated as 52.2 wt % TFEMA, 34.9 wt % SBMA, and 12.9 wt % MAA.

### Example 2. Polymer Architecture

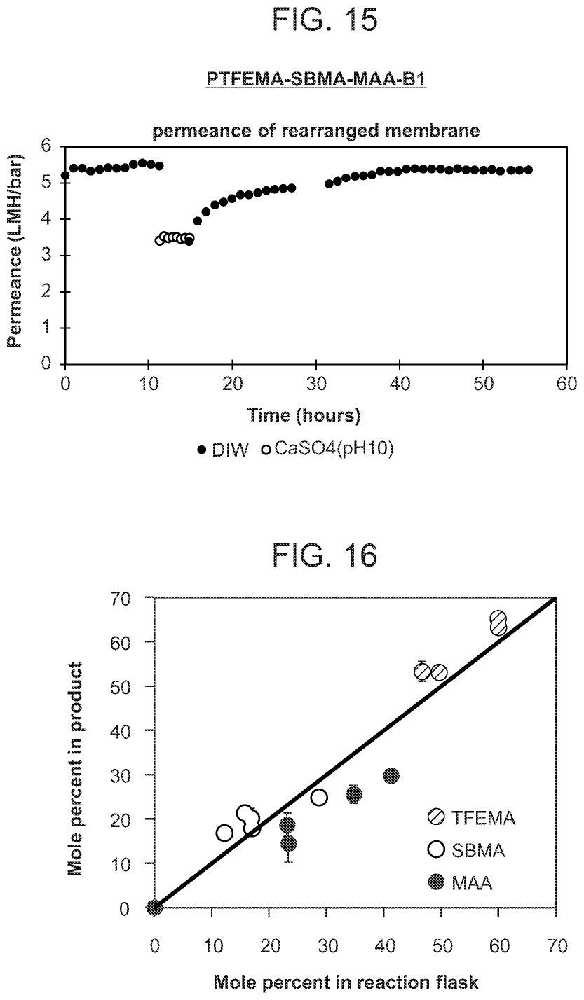

From the data in FIG. 16, it can inferred that the terpolymer has a near-random monomer sequence. The terpolymer composition was similar to the initial reaction conditions, and the yields were ˜70%. This is in contrast with the block architecture that is generally associated with self-assembling copolymers. There are strict kinetic requirements for a terpolymer to be truly random (all six reactivity ratios equal to 1), and so it is possible that the terpolymers are somewhat graded and/or blocky. Within the field, however, the term “random” is not strictly applied. To best communicate the polymer architecture to a wide audience, the terpolymers will therefore be referred as being random.

### Example 3. Formation of Thin Film Composite (TFC) Membranes with PTFEMA-SBMA-MAA terpolymer Selective Layer

### Example 3A. Formation of TFC membranes from PTFEMA-SBMA-MAA-B1

In this example, a TFC membrane was prepared using the polymer described in Example 1A. The copolymer was first dissolved in trifluoroethanol (TFE) at 0.11 g copolymer/mL TFE. The solution was then filtered using a 1 μm glass syringe filter, degassed via heating to 50° C. for 1 hour, and allowed to cool back down to room temperature. Next, a Gardco wire wound rod (wire size 2 ½, which deposits a 6 μm wet film) was used to coat the copolymer solution onto a PES ultrafiltration support membrane (Trisep UE50). After coating, the coated membrane was quickly plunged into a non-solvent bath of isopropyl alcohol (IPA) for 20 minutes, followed by immersion in DI water. This procedure yielded TFC membranes with the selective layer being the PTFEMA-SBMA-terpolymer described in Example 1A.

### Example 3B. Formation of TFC membranes from PTFEMA-SBMA-MAA-B2

In this example, a membrane was prepared using the polymer described in Example 1B. The copolymer was first dissolved in trifluoroethanol (TFE) at 0.11 g copolymer/mL TFE. The solution was then filtered using a 1.2 μm glass syringe filter, degassed via heating to 50° C. for 1 hour, and allowed to cool back down to room temperature. Next, a Gardco universal blade applicator with a 20 μm gate setting was used to coat the copolymer solution onto a PES ultrafiltration support membrane (Trisep UE50). After coating, the film of polymer solution was allowed 15 seconds to evaporate. The coated membrane was then plunged into a nonsolvent bath of isopropyl alcohol (IPA) for 20 minutes, followed by immersion in DI water. This procedure yielded thin film composite (TFC) membranes with the selective layer being the PTFEMA-SBMA-MAA-B2 terpolymer described in Example 1B.

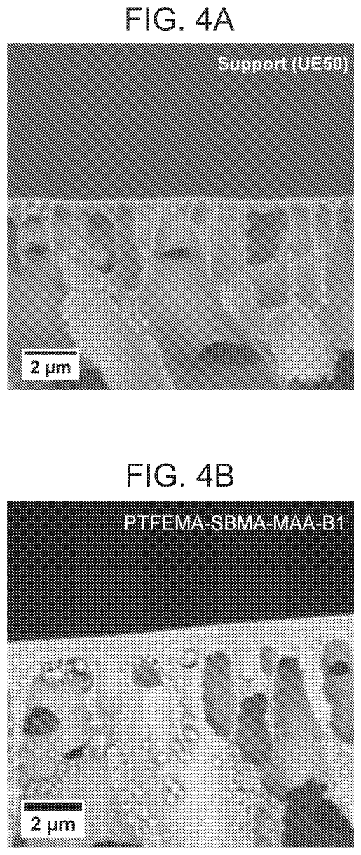

Scanning electron microscopy (SEM) was used to observe the cross-section of the TFC membranes described in Example 2A and Example 2B, which allowed for the selective layer thickness and membrane morphology to be analyzed. To prepare the samples, membrane sections were freeze-fractured and sputter-coated with gold-palladium. SEM images of the membrane cross-section were obtained using a Phenom G2 pure tabletop SEM at a 5 kV setting. FIGS. 4A, 4B, and 4C show the SEM images of the uncoated Trisep UE50 membrane (Support), the TFC membrane from Example 2A, and the TFC membrane from Example 2B. The selective layer is observed to be a dense and 0.5-1 μm in thickness for each of the two examples.

### Example 4. Water Permeance of PTFEMA-SBMA-MAA TFC Membranes

In this example, the pure water permeance of the membranes described in Examples 2A and 2B was measured, and compared to membrane prepared from PTFEMA-SBMA. To carry out the experiments, 10 mL Amicon 8010 stirred cells in dead-end mode was used. The membrane swatch area was 4.1 cm², the stirring speed was 500 RPM, and the pressure was 30 psi for PTFEMA-SBMA-MAA-B 1 membranes and 50 psi for PTFEMA-SBMA-MAA-B2 membranes. To measure membrane permeance, Ohaus Scout Pro scales that were connected to a computer was used. Synchronized measurements of permeate mass versus time allowed for the measurement of membrane flowrate, which allowed for the calculation of membrane permeance. The permeances of PTFEMA-SBMA-MAA-B1 membranes and PTFEMA-SBMA-MAA-B2 membranes was 1.7 L/m².h.bar (abbreviated as LMH/bar) and 2.5 LMH/bar, respectively (Table 1).

TABLE 1
Water permeance and composition of the PTFEMA-
SBMA-MAA-B1 and PTFEMA-SBMA-MAA-B2 membranes
that were described in Examples 3A and 3B

| | Permeance | wt % | wt % | wt % |
|---|---|---|---|---|
| Copolymer | (LMH/bar) | TFEMA | SBMA | MAA |
| PTFEMA-SBMA-MAA-B1 | 1.7 | 61.85 | 31.74 | 6.42 |
| (Example 2A) | | | | |
| PTFEMA-SBMA-MAA-B2 | 2.5 | 52.20 | 34.90 | 12.89 |
| (Example 2B) | | | | |
| PTFEMA-SBMA | 1.41 | 64 | 36 | 0 |

### Example 5. Neutral Solute Rejection By PTFEM-SBMA-MAA TFC Membranes

In this example, various neutral solutes were filtered using the membranes described in Example 3B. The purpose of these experiments was to: (1) to demonstrate the ability of membranes described in Example 3B to filter small neutral molecules from solution, and (2) to establish an effective pore size for the membranes described in Example 3B.

Filtration experiments were carried out using 10 mL Amicon 8010 stirred cells in dead-end mode. The membrane swatch area was 4.1 cm², the stirring speed was 500 RPM, and the pressure was 50 psi for all experiments. The first 1.5 mL of permeate was discarded, and the subsequent 0.7 mL was collected for the measurement of permeate concentration. Permeate concentration was measured using chemical oxygen demand (COD) for sugars, and UV-vis spectroscopy for dyes.

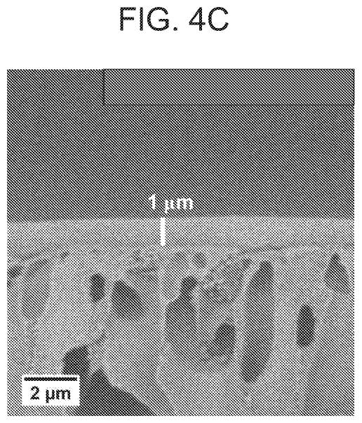

FIG. 5B shows the rejection of neutral sugars and neutral dye molecules. Size selectivity is observed for the neutral solutes that were tested, with Vitamin B12 (1.48 nm hydrated diameter) and β-cyclodextrin (1.54 nm hydrated diameter) rejection around 92% (Table 2). The effective pore size was calculated to be 1.95 nm by fitting the rejection data for sugar molecules to the Extended Nernst Planck Equation with steric hindrance boundary conditions.

TABLE 2
Solute type, hydrated diameter, and rejection of various neutral
solutes filtered by PTFEMA-SBMA-MAA-B2 TFC membranes

| | Solute | Hydrated diameter | Rejection |
|---|---|---|---|
| Solute | type | (nm) | (%) |
| Glucose | sugar | 0.725 | 18.1 |
| Maltose | sugar | 0.94 | 52.1 |
| α-cyclodextrin | sugar | 1.34 | 83.8 |
| β-cyclodextrin | sugar | 1.54 | 91.4 |
| Vitamin B12 | dye | 1.48 | 93.3 |
| Riboflavin | dye | 1.16 | 40.8 |
| Rutin | dye | 1.32 | 62.4 |

### Example 6. Salt Rejection by PTFEMA-SBMA-MAA TFC Membranes

In this example, various ionic solutes were filtered using the TFC membranes described in Example 3B. The purpose of these experiments was: (1) to demonstrate the ability of membranes prepared as described in Example 3B to filter salts from solution, and (2) demonstrate the ability of membranes prepared as described in Example 3B to selectively filter ionic species while passing neutral solutes of the same size.

Filtration experiments were carried out using 10 mL Amicon 8010 stirred cells in dead-end mode. The membrane swatch area was 4.1 cm², the stirring speed was 500 RPM, and the pressure was 50 psi for all experiments. The first 1.5 mL of permeate was discarded, and the subsequent 0.7 mL was collected for the measurement of permeate concentration. Permeate concentration was measured using a conductivity meter. The data is tabulated in Table 3.

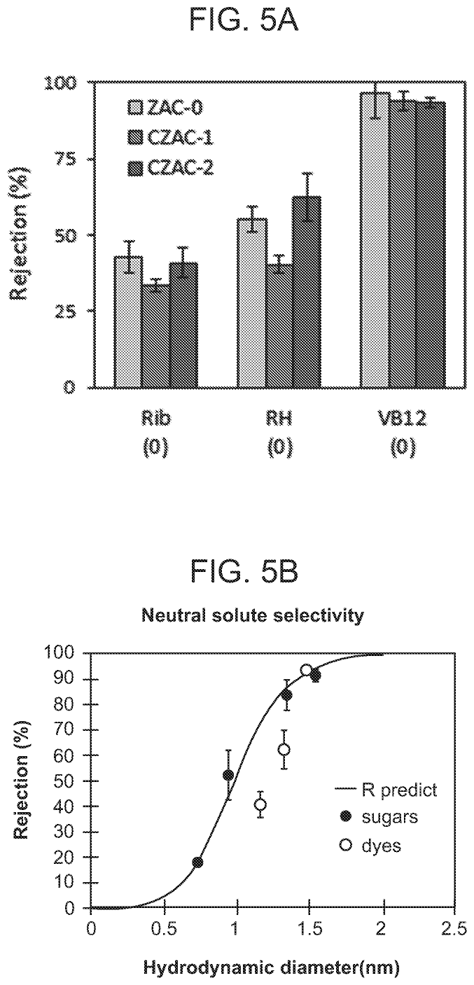

FIG. 6A shows that PTFEMA-SBMA-MAA-B1 membrane and PTFEMA-SBMA-MAA-B2 membrane had a greater rejection of charged solutes than PTFEMA-SBMA membrane. Since neutral solute rejection was equivalent for all three membranes, this finding is evidence that MAA grants anion selectivity to CZAC membranes. The highest rejection was that of Na₂SO₄, in the range of 93-95%. The rejection of CaSO₄was in the range of 40-70%, and the rejection of NaCl was in the range of 30-60%.

To test the hypothesis that deprotonated MAA grants the membrane with charge selectivity, Na₂SO₄ is filtered at varying pH (FIG. 6B). If deprotonated MAA is the source of anion selectivity, then the selectivity should vanish in acidic conditions. As expected, we saw R(Na₂SO₄) decrease with decreasing pH, which can be explained by the shift in equilibrium from deprotonated MAA to protonated MAA. The selectivity loss began in earnest only below pH 5.0, which suggests that the effective pKa of MAA is less than ˜4.0 for our system (the pKa was fit as 3.72 using the Donnan Steric Pore Model coupled with the Henderson Hasselbach Equation; see Supporting).

The effective pKa<4.0 is well below the pKa of 4.78 that is reported for MAA monomer. This implies that MAA is approximately 10 times more reactive when incorporated into the CZAC nanostructure than when in free solution. This contradicted expectations, since it is generally found that confinement leads to reduced MAA reactivity.

FIG. 6C shows the rejection of charged solutes. Firstly, FIG. 6C demonstrates the following two notable performance features of PTFEMA-SBMA-MAA-B2 membranes: (1) 96% rejection of both 1 mM (142 ppm) Na₂SO₄ and 1 mM (110 ppm) Li₂SO₄ solutions; (2) 93% rejection of both 5 mM (710 ppm) Na₂SO₄ and 5 mM (550 ppm) Li₂SO₄ solutions (Table 3). The rejection of CaSO₄ and MgSO₄ was in the range of 40-70%, and the rejection of NaCl and LiCl was in the range of 30-60%. Rejection of solutes decreased with increasing feed concentration, which is consistent with Donnan exclusion. The rejection of varying salt species was understood by fitting the rejection data to the Donnan Steric Pore Model, which is a transport model that describes how the combination of hindered transport, steric exclusion, and Donnan equilibrium determine solute rejection by charged membranes. The ability of the membranes to filter ionic species while passing neutral solutes of the same size can be seen by comparing FIG. 5 and FIG. 6C. Small ionic species (sulfate has a hydrated diameter of 0.46 nm; all ions used in the study have a hydrodynamic diameter less than 0.7 nm) are rejected by the membrane, while neutral solutes of hydrated diameter less than 1.0-1.5 nm are rejected only minimally. Table 3. Concentration and rejection of various salts by the PTFEMA-SBMA-MAA-B2 membrane described in Example 3B.

| | Concentration | Concentration | Rejection |
|---|---|---|---|
| Salt species | (mM) | (ppm) | (%) |
| Na₂SO₄ | 1.0 | 142 | 96.3 |
| | 5.0 | 710 | 93.6 |
| Li₂SO₄ | 1.0 | 110 | 96.1 |
| | 5.0 | 550 | 92.7 |
| CaSO₄ | 1.0 | 136 | 61.9 |
| | 5.0 | 681 | 39.7 |
| MgSO₄ | 1.0 | 120 | 68.9 |
| | 5.0 | 602 | 48.3 |
| NaCl | 1.0 | 58 | 55.8 |
| | 5.0 | 292 | 35.9 |
| LiCl | 1.0 | 42 | 50.2 |
| | 5.0 | 212 | 33.3 |

### Example 7. Rejection of Dyes and Na₂SO₄ by PTFEMA-SBMA-MAA TFC Membranes Compared to that of PTFEMA-r-SBMA TFC Membranes

In this example, the rejection of dyes and Na₂SO₄ by the TFC membranes prepared in Example 3A was determined and compared to that of PTFEMA-r-SBMA TFC membranes (termed PTFEMA-SBMA.) The synthesis of PTFEMA-SBMA and fabrication of PTFEMA-SBMA TFC membranes can be found elsewhere. It is noted here that the main difference between PTFEMA-SBMA membranes and PTFEMA-SBMA-MAA membranes is that PTFEMA-SBMA membranes lack MAA, and therefore should have a lower rejection of charged solutes. The purpose of these experiments was to: (1) demonstrate the ability of the PTFEMA-SBMA-MAA-B1 membranes to filter dyes from solutions, a feature which would be useful in applications such dye removal in the textile industry; (2) to further demonstrate the charge selectivity observed with PTFEMA-SBMA-MAA TFC membranes, with PTFEMA-SBMA TFC membranes serving as an appropriate control.

Filtration experiments were carried out using 10 mL Amicon 8010 stirred cells in dead-end mode. The membrane swatch area was 4.1 cm², the stirring speed was 500 RPM, and the pressure was 27 psi for all experiments. The first 1.8 mL of permeate was discarded, and the subsequent 0.7 mL was collected to measure the concentration of the permeate. Permeate concentration was measured using UV vis spectroscopy for dyes, and conductivity for Na₂SO₄. The diameter of the dye molecules was obtained by assuming that the dye molecules were spheres of volume Vₘₒₗₐᵣ, where Vₘₒₗₐᵣ is the molar volume of the dye molecule; the molar volume of the dyes was obtained using Molecular Modeling Pro software by ChemSW.

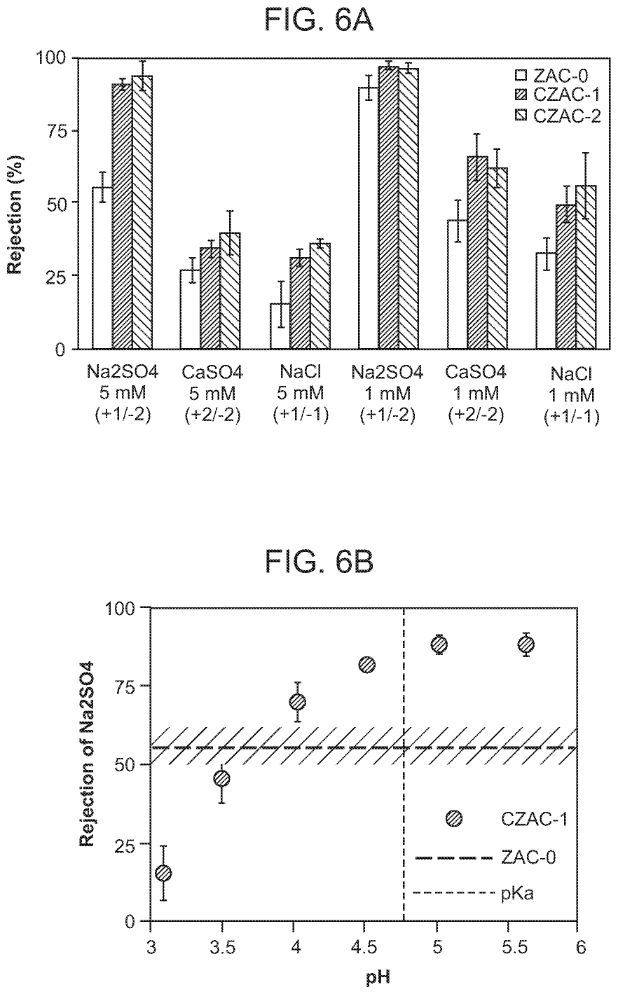

FIG. 7A and FIG. 7B show the rejection of the various dyes and Na₂SO₄. Table 4 tabulates the abbreviations, calculated diameter, charge, and rejection of the solutes by the PTFEMA-SBMA-MAA-B1 membranes and the PTFEMA-SBMA membranes. The rejection of neutral dyes is similar for PTFEMA-SBMA-MAA-B1 membranes and PTFEMA-SBMA membranes, which indicates a similar effective pore size. In contrast, the rejection of anionic solutes by the PTFEMA-SBMA-MAA-B1 membranes is greater than that of the PTFEMA-SBMA membranes. This provides evidence that membranes fabricated from CZACs achieve greater exclusion of charged solutes than membranes fabricated from copolymers of only a zwitterionic monomer and a hydrophobic monomer. Furthermore, the exclusion of charged solutes can be explained by the presence of MAA in the PTFEMA-SBMA-MAA-B1 copolymer: MAA, being a weak acid, attains a negative charge upon deprotonation in aqueous solution. If MAA is incorporated in the zwitterionic domain of the self-assembled PTFEMA-SBMA-MAA-B1 selective layer, then it could endow the nanochannels of the membrane with a negative charge. This would lead to an enhanced rejection of ionic species though a well-documented phenomenon known as Donnan exclusion.

TABLE 4
Abbreviations, calculated diameter, charge, and rejection of the solutes by
the TFC membranes described in Example 2A and PTFEMA-r-SBMA TFC membranes

| | | Calculated | | | |
|---|---|---|---|---|---|
| | | diameter | | Rejection (%) | |
| Abbreviation | Solute | (nm) | Charge | PTFEMA-SBMA-MAA-B1 | PTFEMA-SBMA |
| Rib | riboflavin | 0.83 | 0 | 36.9 | 47.7 |
| RH | rutin | 1 | 0 | 50.5 | 62.2 |
| | hydrate | | | | |
| VB12 | vitamin | 1.3 | 0 | 95.1 | 96.6 |
| | b12 | | | | |
| Na2SO4 | sodium | n/a (small) | −2 | 92.9 | 52.6 |
| | sulfate | | | | |
| MO | methyl | 0.79 | −1 | 83.9 | 77.3 |
| | orange | | | | |
| AB45 | acid blue 45 | 0.84 | −2 | 99.1 | 96.1 |

### Example 8. Fouling Resistance of PTFEMA-SBMA-MAA TFC Membranes

Zwitterions are one of the most fouling resistant materials currently known. This is because the foulant-surface adsorption event that constitutes fouling is limited by the strong hydration shell that surrounds zwitterions (ΔG_{hydration}˜−500 kJ/mol according to simulations). Previous work has shown that membranes comprised of random zwitterionic copolymers are highly fouling resistant, which proves that zwitterions are still able to act as anti-fouling agents from within the confines of the membrane nanostructure. To test if this rule extends to CZAC membranes, dead-end filtration using different model foulants is performed. Commercial NF membranes were used as benchmarks. The membranes were fouled for 24 hours, and the initial flux of the CZAC membrane was matched to that of the benchmark.

In this example, the fouling resistance of the PTFEMA-SBMA-MAA-B2 membrane described in Example 3B was measured using oil-in-water emulsions. The purpose of this was to show that the membranes are fouling resistant, which is a vital feature for any membrane that is pitted against a fouling-prone feedstock.

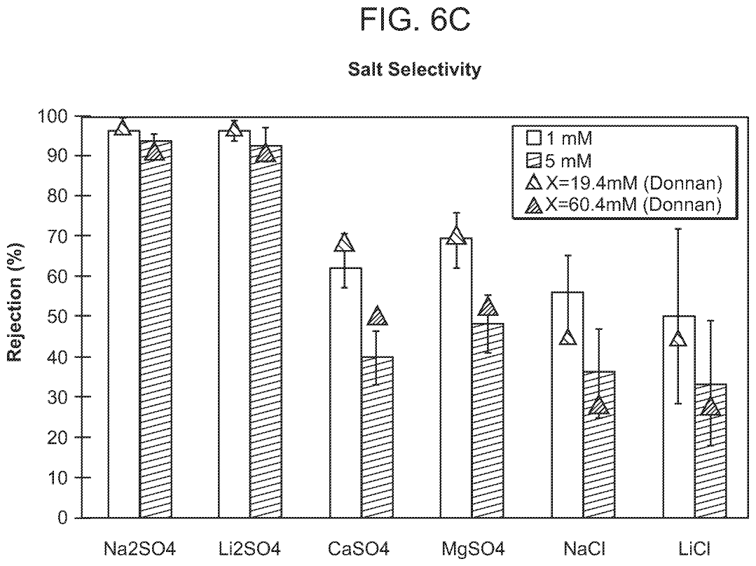

Fouling experiments were carried out using 10 mL Amicon 8010 stirred cells in dead-end mode. The membrane swatch area was 4.1 cm², the stirring speed was 500 RPM, and the pressure was 50 psi for all experiments. To measure membrane permeance versus time, we used Ohaus Scout Pro scales that were connected to a computer. Synchronized measurements of permeate mass versus time allowed for the measurement of membrane flowrate, which allowed for the calculation of membrane permeance. The normalized permeance, which is permeance divided by the average DIW permeance before introducing the membrane to foulant, was calculated. Oil emulsions were prepared by blending surfactant, oil, and water together on <high> for 5 minutes. The mass ratio of surfactant: oil was 1:9, and the concentration of oil was 1500 mg/L in the stabilized emulsion. Span80 surfactant was for one fouling experiment, and DC 193 surfactant was used for the other. FIG. 8A and FIG. 8B show the above two fouling experiments performed. All reveal PTFEMA-SBMA-MAA-B2 membranes to be fouling resistant.

FIG. 8C shows the fouling resistance of PTFEMA-SBMA-MAA-B1 against BSA/CaCl₂ (1000 ppm and 10 mM, respectively), with the NP30 (Microdyne; PES) serving as the control. BSA is a common model protein foulant, and calcium salts were added to increase its adsorption propensity. PTFEMA-SBMA-MAA-B 1 was seen to foul significantly less than the NP30 throughout the 24 hours fouling experiment. After a brief rinse of the membranes, PTFEMA-SBMA-MAA-B 1 had a complete recovery of flux, which verifies that the adsorption event was reversible. The NP30, in contrast, was irreversibly fouled.

FIG. 8D shows the fouling resistance of PTFEMA-SBMA-MAA-B2 against humic acid/ alginate (1000 ppm each), with the UA60 (Trisep; PA) serving as the control. The pH was reduced with HCl to 4.5 in order to increase adsorption propensity. PTFEMA-SBMA-MAA-B2 fouled less than the UA60 throughout the 24 hours fouling experiment. Immediately after a brief rinse, PTFEMA-SBMA-MAA-B1 had a 93% recovery of initial flux, with the permeance climbing back to 96% of the initial value after 5 hours. The UA60 suffered a greater initial drop (82% recovery immediately after rinse), and eventually reached 93% recovery after 13 hours.

### Example 9. Chlorine Resistance of PTFEMA-SBMA-MAA-B1 TFC Membranes

In this example, PTFEMA-SBMA-MAA-B1 membrane was exposed to a solution of containing a chlorinated solution, prepared by diluting commercial Clorox bleach and adjusting its pH to an acidic value in agreement with commercial cleaning procedures. The purpose of this was to demonstrate that the PTFEMA-SBMA-MAA-B1 membranes are resistant to chlorine, which would enable the membranes to be cleaned with sodium hypochlorite, a commonplace disinfectant. The polyamide membranes that represent the cornerstone of the NF market are not stable upon exposure to chlorine, which is a major disadvantage of the technology.

To carry out the experiments, 10 mL Amicon 8010 stirred cells in dead-end mode was used. The membrane swatch area was 4.1 cm², the stirring speed was 500 RPM, and the pressure was 50 psi. To measure membrane permeance, Ohaus Scout Pro scales that were connected to a computer was used. Synchronized measurements of permeate mass versus time allowed for the measurement of membrane flowrate, which allowed for the calculation of membrane permeance. The deionized water permeance of the membrane was measured as described above. The chlorinated solution was prepared by diluting commercial Clorox laundry bleach with deionized water and adjusting its pH to 4 in order to ensure that the vast majority of hypochlorite was hypochlorous acid. The final HClO concentration was estimated to be around 15,000 mg/L. The membrane swatch was exposed to this solution for 1-2 hours. Then, the permeance was measured again.

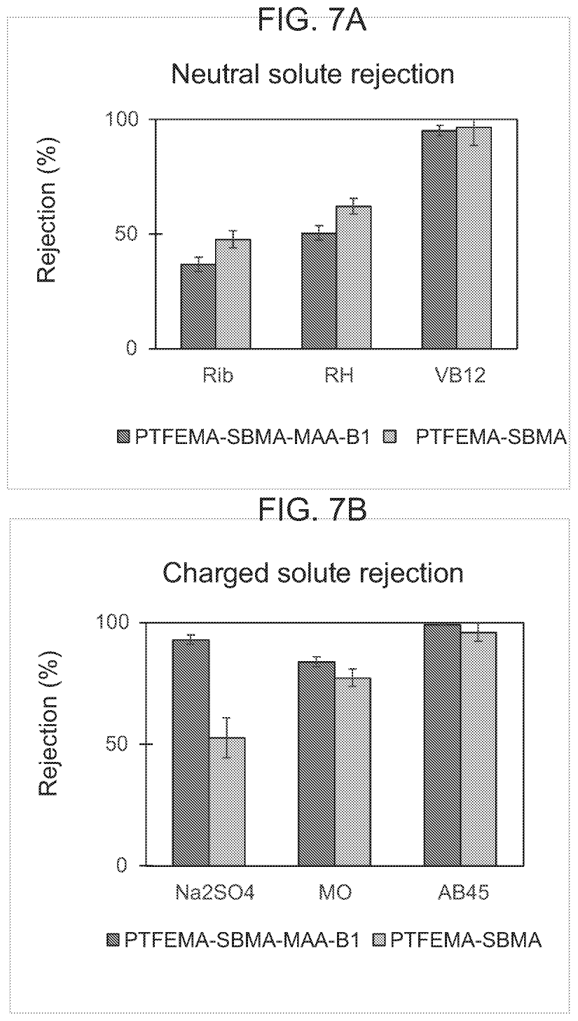

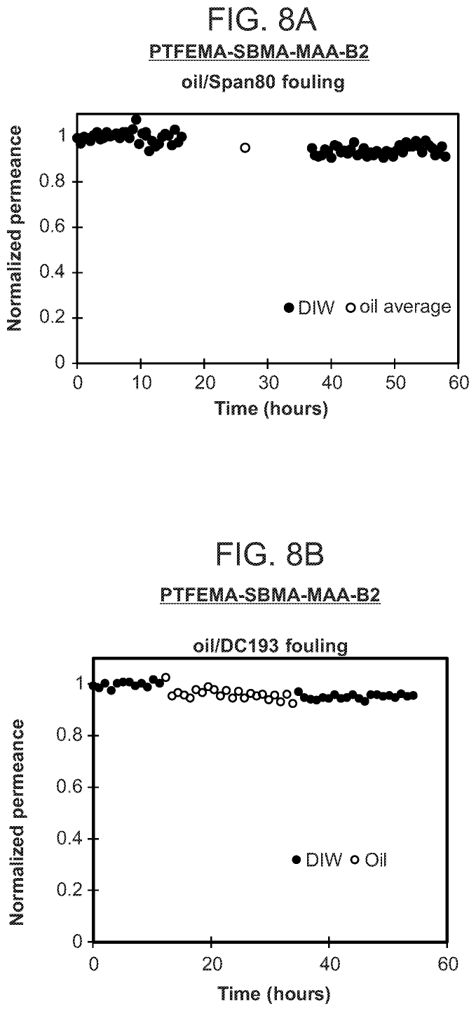

FIG. 9 reveals that the permeance of the membrane remained unaltered upon treatment with the chlorinated solution, indicating that the membrane remains stable upon exposure to chlorine. FIG. 10 shows the effect of chlorine treatment on PTFEMA-SBMA-MAA-B2 bond chemistry. FTIR spectra taken before and after 16 hours of immersion in 2,000 ppm sodium hypochlorite solution at pH 4.5 shows that the structure remained in intact before and after the exposure.

TABLE 5
Effect of chlorine treatment on CZAC-2 (PTFEMA-SBMA-
MAA-B2) permeance and selectivity. Membrane performance
data taken before and after 16 hours of immersion
in 2,000 ppm NaClO solution (pH 4.5)

| | Permeance | | Rejection of | | Rejection of 5 mM | |
|---|---|---|---|---|---|---|
| | (LMH/bar) | | VB12 (%) | | Na2SO4 | |
| Membrane | before | after | before | after | before | after |
| CZAC-2 | 1.81 | 1.81 | 93.14 | 90.3 | 94.4 | 93.6 |
| UA60 | 12.3 | 8.4 * (was | 99.5 | 99.4 | 78.7 | 97.4 |
| | | not stable) | | | | |

### Example 10. Base Rearrangement Observed in PTFEMA-r-SBMA-r-MAA TFC Membranes

In this example, the irreversible response of PTFEMA-SBMA-MAA-B1 membranes to bases (termed base rearrangement) was investigated. The purpose of this was to reveal the unique response behavior of membranes derived from this new material. Filtration experiments were carried out using 10 mL Amicon 8010 stirred cells in dead-end mode. The membrane swatch area was 4.1 cm², the stirring speed was 500 RPM, and the pressure was in the range of 30-50 psi for all experiments.

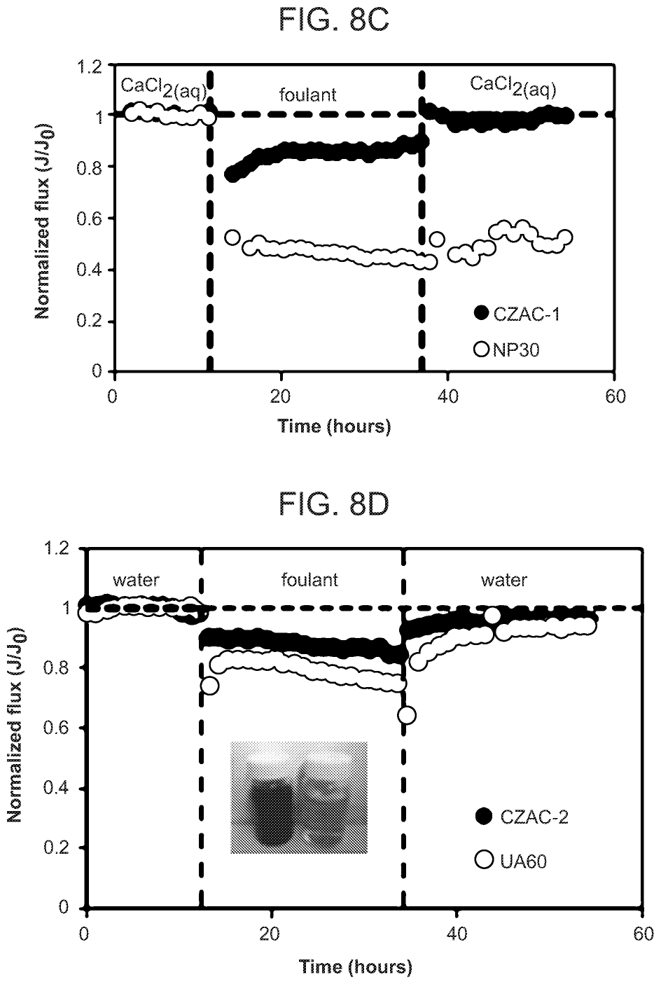

FIG. 11 shows the base rearrangement of PTFEMA-SBMA-MAA-B1 membranes to an alkaline buffer system (PBS, pH=7.4.) The permeance increased from the initial value of ˜1.8 LMH/bar to ˜2.8 LMH/bar upon initial exposure to the 10 mM solution of PBS. Upon contacting the membrane with DIW, the permeance increased to ˜5.1 LMH/bar in distilled water (DIW.) After the base rearrangement, the permeance can be reversibly and quickly switched between 5.1 LMH/bar in DIW and 2.8 LMH/bar in PBS. There is evidence that TFC membranes with a selective layer comprised only of a hydrophobic monomer and a zwitterionic monomer show no such response to PBS.⁴

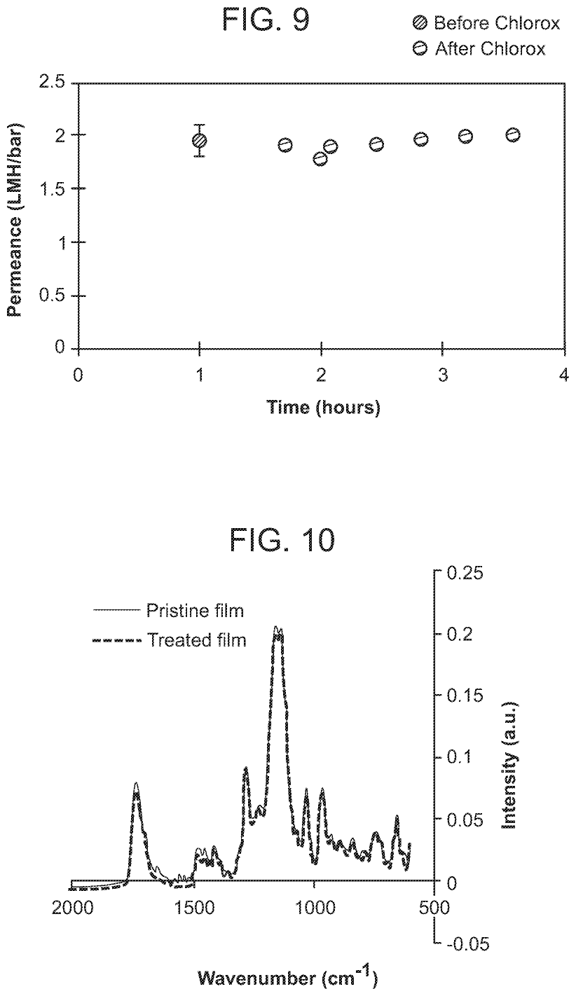

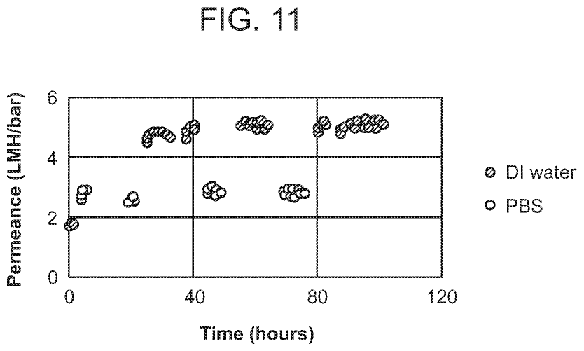

For the rearrangement seen in FIG. 11, it was suspected deprotonation of acidic MAA protons by HPO₄²⁻ (the strongest base in PBS) was the driving force. To test this hypothesis, we performed the following experiment. First, Vitamin B12 rejection, Na₂SO₄ rejection, and permeance of pristine PTFEMA-SBMA-MAA-B1 membrane was determined. We then filtered NaOH_{(aq)} (pH 11, 0.1 mM) through the membrane, during which we measured the permeance. The membrane was then switched back to DIW to see if the same irreversible response had occurred. Afterwards, we again measured Vitamin B12 rejection and Na₂SO₄ rejection. FIG. 12A and FIG. 12B show the results of this experiment, and reveals that NaOH_{(aq)} is indeed able to bring about the base rearrangement observed with PBS. It is also noted that no rearrangement was observed with PTFEMA-SBMA membranes. FIG. 13 demonstrates that the rejection of Vitamin B12 and Na₂SO₄ both decreased after exposure to NaOH_{(aq)}, although it is noted that Vitamin B12 rejection declined more than Na₂SO₄.

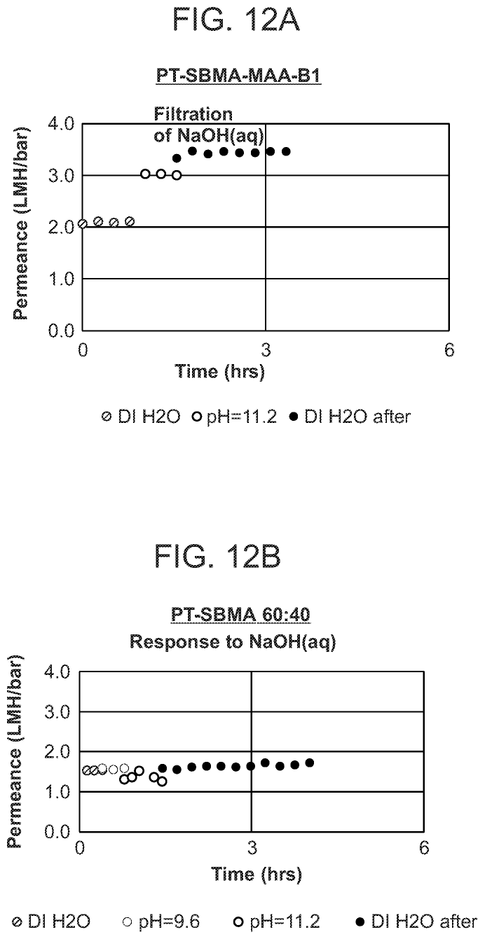

The permeance of the membranes during filtration experiments for Example 2A and Example 2B was consistently measured using a simple mass balance. The results for filtration experiments, which captured 17 different uncharged/charged/dye solutes, is shown in FIG. 14 (see Table 6 for the tabulation of filtration ID.) Membrane flux was unaffected during and after filtration with these solutes. This further implicates interactions with bases as the root cause of the rearrangement for PTFEMA-SBMA-MAA membranes.

TABLE 6
Tabulation of filtration ID

| Filtration ID | Solute |
|---|---|
| 1 | Beta cyclodextrin |
| 2 | Maltose |
| 3 | Alpha cyclodextrin |
| 4 | Na₂SO₄ (1 mM) |
| 5 | Na₂SO₄ (5 mM) |
| 6 | 1 mM CaSO₄ (1 mM) |
| 7 | CaSO₄ (5 mM) |
| 8 | MgSO₄ (1 mM) |
| 9 | MgSO₄ (5 mM) |
| 10 | NaCl (1 mM) |
| 11 | NaCl (5 mM) |
| 12 | Li₂SO₄ (1 mM) |
| 13 | Li₂SO₄ (5 mM) |
| 14 | LiCl (1 mM) |
| 15 | LiCl (5 mM) |
| 16 | NaI (1 mM) |
| 17 | Na Acetate (1 mM) |
| 18 | LiClO₄ (1 mM) |
| 19 | Brilliant blue R |
| 20 | Acid blue 45 |

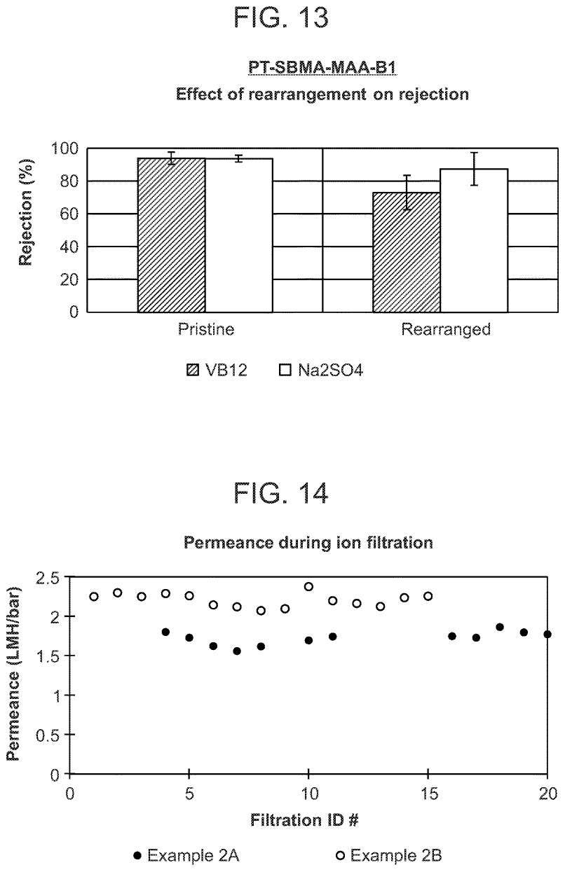

We also probed at how base-rearranged PTFEMA-SBMA-MAA-B1 membranes respond to basic solutions containing cations other than sodium and potassium (NaOH_{(aq)} contains sodium as the cation; PBS contains sodium and potassium as the cations.) Calcium is known to bind with carboxylate, and so it was though that the binding interaction might have an impact on membrane flux. For this experiment, we measured permeance of a base rearranged PTFEMA-SBMA-MAA-B1 membrane with the feed being a basic (pH=10) solution of CaSO₄. FIG. 15 shows the results of this, which indicate a long recovery time for the DIW flux. This suggests that interactions between cations and deprotonated MAA result in the reduced permeance of rearranged PTFEMA-SBMA-MAA membranes.

### REFERENCES CITED

1. Asatekin Alexiou, A.; Bengani, P. Zwitterion Containing Membranes. U.S. Application 61901624, 2013.

2. Bengani, P.; Kou, Y.; Asatekin, A., Zwitterionic copolymer self-assembly for fouling resistant, high flux membranes with size-based small molecule selectivity. Journal of Membrane Science 2015, 493, 755-765.

3. Bengani-Lutz, P.; Asatekin Alexiou, A. Fabrication of filtration membranes. Patent application 62/416,340, Nov. 2, 2016, filed 2016.

4. Bengani-Lutz, P.; Converse, E.; Cebe, P.; Asatekin, A., Self-Assembling Zwitterionic Copolymers as Membrane Selective Layers with Excellent Fouling Resistance: Effect of Zwitterion Chemistry. ACS Applied Materials & Interfaces 2017, 9 (24), 20859-20872.

5. Bengani-Lutz, P.; Zaf, R. D.; Culfaz-Emecen, P. Z.; Asatekin, A., Extremely fouling resistant zwitterionic copolymer membranes with ˜1 nm pore size for treating municipal, oily and textile wastewater streams. Journal of Membrane Science 2017, 543 (Supplement C), 184-194.

6. Sadeghi, I.; Asatekin, A., Spontaneous Self-Assembly and Micellization of Random Copolymers in Organic Solvents. Macromolecular Chemistry and Physics 2017, 218 (20), 1700226.

7. Sadeghi, I.; Asatekin, A., Membranes with Functionalized Nanopores for Aromaticity-Based Separation of Small Molecules. ACS Applied Materials & Interfaces 2019, 11 (13), 12854-12862.

8. Asatekin Alexiou, A.; Sadeghi, I. Two-layer nanofiltration membranes. Patent application 62/131,001, Mar. 10, 2015, 2015.

9. Ji, Y. L.; An, Q. F.; Zhao, Q.; Sun, W. D.; Lee, K. R.; Chen, H. L.; Gao, C. J., Novel composite nanofiltration membranes containing zwitterions with high permeate flux and improved anti-fouling performance. Journal of Membrane Science 2012, 390, 243-253.

10. Petersen, R. J., Composite Reverse Osmosis and Nanofiltration Membranes. Journal of Membrane Science 1993, 83 (1), 81-150.

11. Bengani-Lutz, P. Zwitterionic Copolymer Self-assembly for Fouling Resistant, High Flux Membranes with Small Molecule Selectivity. Ph.D. Thesis, Tufts University, 2017.

We claim:

1. A copolymer, comprising a plurality of zwitterionic monomeric units, a plurality of charged/ionizable monomeric units, and a plurality of hydrophobic monomeric units.

2. The copolymer of claim 1, wherein the molecular weight of the copolymer is 20,000 g/mol to 1,000,000 g/mol.

3. The copolymer of claim 1, wherein the molecular weight of the copolymer is 40,000 g/mol to 1,000,000 g/mol.

4. The copolymer of claim 1, wherein the molecular weight of the copolymer is 100,000 g/mol to 1,000,000 g/mol.

5. The copolymer of any one of claims 1-4, wherein the zwitterionic monomeric units constitute 1-40 wt % of the copolymer.

6. The copolymer of any one of claims 1-5, wherein the charged/ionizable monomeric units constitute 1-40 wt % of the copolymer.

7. The copolymer of any one of claims 1-6, wherein the hydrophobic monomeric units constitute 30-80 wt % of the copolymer.

8. The copolymer of any one of claims 1-7, wherein each of the zwitterionic monomeric units is formed from a monomer comprising sulfobetaine, carboxybetaine, or phosphorylcholine moieties.

9. The copolymer of any one of claims 1-7, wherein each of the zwitterionic monomeric unit is formed from a monomer selected from the group consisting of sulfobetaine methacrylate (SBMA), methacryloxy phosphoryl choline (MPC), carboxybetaine methacrylate (CBMA), sulfobetaine-2-vinylpyridine, sulfobetaine-4-vinylpyridine, and sulfobetaine-vinyl imidazole.

10. The copolymer of any one of claims 1-7, wherein each of the zwitterionic monomeric units is formed from sulfobetaine methacrylate (SBMA).

11. The copolymer of any one of claims 1-10, wherein each of the charged/ionizable monomeric units is formed from a monomer selected from the group consisting of a methacrylate, an acrylate, an acrylamide or a styrene derivative comprising carboxylic acid, sulfonate, phosphate, or amine moieties.

12. The copolymer of any one of claims 1-10, wherein each of the charged/ionizable monomeric units is formed from a monomer selected from the group consisting of methacrylic acid (MAA), acrylic acid, 2-carboxyethyl acrylate, 2-carboxyethyl methacrylate, styrene sulfonate, 3-sulfopropyl acrylate, 3-sulfopropyl methacrylate, 2-acrylamido-2-methyl-1-propanesulfonic acid, 2-(dimethylamino)ethyl methacrylate, 2-(diethylamino)ethyl methacrylate, 2-aminoethyl methacrylate, [2-(methacryloyloxy)ethyl]trimethylammonium chloride, [2-(acryloyloxy)ethyl]trimethylammonium chloride, 2-(diethylamino)ethyl acrylate, 2-(dimethylamino)ethyl acrylate, 3-(dimethylamino)propyl acrylate, N-acryloyl-L-valine, (3-acrylamidopropyl)trimethylammonium chloride, N[3-(dimethylamino)propyl]methacrylamide, 2-isopropenylaniline, 4-[N-(methylaminoethyl)aminomethyl]styrene, and (vinylbenzyl)trimethylammonium chloride.

13. The copolymer of any one of claims 1-10, wherein each of the charged/ionizable monomeric units is formed from methacrylic acid (MAA).

14. The copolymer of any one of claims 1-13, wherein each of the hydrophobic monomeric units is formed from a monomer selected from the group consisting of styrene, methyl methacrylate, acrylonitrile, a fluoroalkyl acrylate, a fluoroaryl acrylate, a fluoroalkyl methacrylate, a fluoroaryl methacrylate, a fluoroalkyl acrylamide, and a fluoroaryl acrylamide.

15. The copolymer of any one of claims 1-13, wherein each of the hydrophobic monomeric units is formed from a monomer selected from the group consisting of 2,2-trifluoroethyl methacrylate (TFEMA), pentafluoropropyl methacrylate, heptafluorobutyl methacrylate, and pentafluorophenyl methacrylate.

16. The copolymer of any one of claims 1-13, wherein each of the hydrophobic monomeric units is formed from 2,2-trifluoroethyl methacrylate (TFEMA).

17. The copolymer of any one of claims 1-16, wherein the hydrophobic monomeric units are characterized in that a homopolymer formed thereof has a glass transition temperature above room temperature.

18. The copolymer of any one of claims 1-17, wherein the copolymer is a linear copolymer; the copolymer is a statistical copolymer; the copolymer is a random copolymer;
or the copolymer is a linear, statistical, random copolymer.

19. The copolymer of any one of claims 1-18, wherein the copolymer is poly((sulfobetaine methacrylate)-random-(methacrylic acid)-random-(2,2-trifluoroethyl methacrylate)).

20. A polymeric material, comprising a copolymer of any one of claims 1-19.

21. The polymeric material of claim 20, wherein the polymeric material is in the form of a thin film.

22. A thin film composite membrane, comprising a porous support, and a thin film of the polymeric material of claim 21; wherein the pore size of the porous support is larger than the pore size of the thin film of the polymer material.

23. The thin film composite membrane of claim 22, wherein the thin film of the polymeric material has a thickness of 1 nm to 10 μm.

24. The thin film composite membrane of claim 22, wherein the thin film of the polymeric material has a thickness of 1 nm to 3 μm.

25. The thin film composite membrane of claim 22, wherein the thin film of the polymeric material has a thickness of 1 nm to 1 μm.

26. The thin film composite membrane of any one of claims 22-25, wherein the thin film of the polymeric material has an effective pore size of 0.1 nm to 5 nm.

27. The thin film composite membrane of any one of claims 22-25, wherein the thin film of the polymeric material has an effective pore size of 0.6 nm to 3 nm.

28. The thin film composite membrane of any one of claims 22-25, wherein the thin film of the polymeric material has an effective pore size of 0.6 nm to 2 nm.

29. The thin film composite membrane of any one of claims 22-28, wherein the thin film composite membrane exhibits resistance to fouling by an oil emulsion.

30. The thin film composite membrane of any one of claims 22-29, wherein the thin film composite membrane is stable upon exposure to chlorine bleach (e.g., at pH 4).

31. The thin film composite membrane of any one of claims 22-30, wherein the thin film composite membrane undergoes a one-time, irreversible change in pore size upon exposure to buffers with high pH.

32. The thin film composite membrane of any one of claims 22-31, wherein the thin film composite membrane exhibits size-based selectivity between uncharged organic molecules.

33. The thin film composite membrane of any one of claims 22-32, wherein the thin film composite membrane rejects charged solutes and salts.

34. A method of size-based selection or exclusion, comprising contacting a solution comprising a plurality of uncharged organic molecules of different sizes with a thin film composite membrane of any one of claims 22-33.

35. A method of charge-based selection or exclusion, comprising contacting a solution comprising a plurality of salts with a thin film composite membrane of any one of claims 22-33.
